(19) United States
(12) Patent Application Publication
(10) Pub. No.: US 2005/0108928 A1
(43) Pub. Date: May 26, 2005

(54) Soil mediums and alternative fuel mediums, methods of their production and uses thereof

(76) Inventors: Foye Sparks, Irvine, CA (US); Morris Peltier, New Iberia, CA (US)

Correspondence Address: BINGHAM, MCCUTCHEN LLP, THREE EMBARCADERO CENTER, 18 FLOOR, SAN FRANCISCO, CA, 94111-4067, US

(21) Appl. No.: 10/924,709

(22) Filed: Aug. 23, 2004

Related U.S. Application Data
(60) Provisional application No. 60/497,062, filed on Aug. 22, 2003.

(51) Int. Cl. B01D 37/00; C10L 5/00

(52) U.S. Cl. 44/605

(57) ABSTRACT

A process of producing soil mediums or alternative fuel mediums from organic wastes or sludges comprises: a) providing at least one collection of organic wastes or sludges; b) providing a heated air system; c) providing an exhaust system coupled to the heated air system; d) introducing the at least one collection of organic wastes or sludges to the heated air system; e) operating the heated air system in order to convert the at least one collection of organic wastes or sludges to a soil medium or alternative fuel medium; f) exhausting and/or removing any dust particles or undesirable gases by utilizing the exhaust system.

This application claims priority to U.S. Provisional Patent Application Ser. No. 60/497,062 filed on Aug. 22, 2004, which is incorporated by reference in its entirety.

### FIELD OF THE SUBJECT MATTER

The field of the subject matter is the conversion of organic waste products into soil mediums or alternative fuel mediums, and specifically the conversion of organic sludges into non-odoriferous, non-pathogenic, relatively virus-free soil mediums or alternative fuel mediums.

### BACKGROUND OF THE SUBJECT MATTER

The daily production of millions of tons of various organic wastes and by products annually can be primarily attributed to the operations of municipalities and various industries, such as the animal and poultry industries. Waste management costs, coupled with rising interest for resource recovery and environmentally safe practices, have promoted tremendous activity to develop alternative processes and treatment technologies to manage non-hazardous wastes.

Municipalities, for example, produce in excess of 350 million tons of bio-solids each year. At the same time, landfills are diminishing creating future disposal problems. Composting and incineration can be used, but both options are limited in their feasibility. Incineration creates exhaust fumes that can contain components that are damaging to the ozone layer or are considered greenhouse gases. Composting, another alternative, requires less general space than a landfill, but the composting process takes time to work. “Land spreading” is yet another alternative being explored to handle the large amount of the municipality wastes, but the bio-solids are mostly considered Class B wastes that contain pathogens and other enteric bacteria and odor. Also, land spreading is susceptible to runoff, which can be a significant source of pollution, such as ground water pollution.

Paper mills, fish and feed processing wastes approach 150 million tons or more a year. Animal and poultry industries produce at least 100 million tons of waste products per year. These waste products are causing significant concerns because of disposal, concentrated usage and lagoon storage contributes to pollution. The high nutrient values in the water and solids also require expensive treatment methods, which these industries cannot economically afford. In addition, serious health threats can emerge as the result of natural disasters, such as hurricanes or floods, that would give rise to increased pollution, such as that from the hog farms in North Carolina during and after Hurricane Hugo.

Commercial organizations are constantly assessing the potential value of the resources that can be extracted from organic wastes and sludges, especially if the materials are mass reduced because of high moisture content, disinfected of bacteria and viruses and are free of obnoxious odors.

Therefore, it would be beneficial to develop a process that can a) efficiently convert organic wastes and sludges into soil mediums or alternative fuel mediums; b) ensure that the soil mediums and alternative fuel mediums are non-odoriferous, non-pathogenic and/or virus-free; c) mass reduce large quantities of organic sludges and wastes; d) mass reduce organic wastes and sludges by a 5 to 1 ratio; e) produce soil mediums or alternative fuel mediums that are or approach Class A or “exceptional quality” rating making them safe to recycle and/or f) convert both solids and liquids to soil mediums or alternative fuel mediums, where the treated solids can be safely recycled to agriculture markets and liquids can be recycled as wash-down water, beneficially recycled for reuse in the manufacturing of the original product or recycled for irrigation.

### SUMMARY OF THE SUBJECT MATTER

A process of producing soil mediums or alternative fuel mediums from organic wastes or sludges comprises: a) providing at least one collection of organic wastes or sludges; b) providing a heated air system; c) providing an exhaust system coupled to the heated air system; d) introducing the at least one collection of organic wastes or sludges to the heated air system; e) operating the heated air system in order to convert the at least one collection of organic wastes or sludges to a soil medium or alternative fuel medium; and f) exhausting any dust particles or undesirable gases by utilizing the exhaust system.

### BRIEF DESCRIPTION OF THE FIGURE

FIG. 1 shows a contemplated arrangement for processing organic wastes and sludges according to the subject matter herein, comprising a mixer coupled to a burner, a product outlet, a food intake and a dust collector by a plurality of conduits or pipes. The food intake is coupled to a hopper, and the dust collector is coupled to an exhaust fan and exhaust conduits or pipes.

### DETAILED DESCRIPTION

In order to address the goals previously mentioned, a process has been advantageously developed that can a) efficiently convert organic wastes and sludges into soil mediums or alternative fuel mediums; b) ensure that the soil mediums and alternative fuel mediums are non-odoriferous, non-pathogenic and/or virus-free; c) mass reduce large quantities of organic sludges and wastes; d) mass reduce organic wastes and sludges by a 5 to 1 ratio; e) produce soil mediums or alternative fuel mediums that are or approach Class A or “exceptional quality” rating making them safe to recycle and/or f) convert both solids and liquids to soil mediums or alternative fuel mediums, where the treated solids can be safely recycled to agriculture markets and liquids can be recycled as wash-down water.

A process of producing soil mediums or alternative fuel mediums from organic wastes or sludges in a chemical-free environment comprises: a) providing at least one collection of organic wastes or sludges; b) providing a heated air system; c) providing an exhaust system coupled to the heated air system; d) introducing the at least one collection of organic wastes or sludges to the heated air system; e) operating the heated air system in order to convert the at least one collection of organic wastes or sludges to a soil medium or alternative fuel medium; and f) exhausting or removing any dust particles or undesirable gases by utilizing the exhaust system.

Once produced, the soil mediums and/or alternative fuel mediums are reduced by at least a 3 to 1 ratio, and in some embodiments by a 4 to 1 ratio, and in yet other embodiments by at least a 5 to 1 ratio. Contemplated processes also disinfect the organic wastes and sludges of bacteria, viruses and remove foul odors, while making the end product safe and recyclable.

Sludges, in general, are produced from the process of treatment of waste water. Due to the physico-chemical processes involved in the treatment, the sludge tends to concentrate heavy metals and poorly biodegradable trace organic compounds as well as potentially pathogenic organisms (viruses, bacteria etc) present in waste waters. Sludge is, however, rich in nutrients such as nitrogen and phosphorous and contains valuable organic matter that is useful when soils are depleted or subject to erosion. The organic matter and nutrients are the two main elements that make the spreading of this kind of waste on land as a fertilizer or an organic soil medium suitable. Municipal sludges are generally the end products of a microbial food chain in the wastewater treatment process.

During the process contemplated herein, at least one collection of organic wastes or sludges is provided. It is contemplated that “a collection” of organic wastes or sludges is a batch of wastes or sludges that are collected from one source, such as a municipality landfill, an animal or poultry plant, a paper mill, the feed or fish processing industries, etc. Therefore, by providing at least one collection of organic wastes or sludges, it is contemplated that there may be organic wastes or sludges from one source or several sources. The terms “provided” or “providing” are used herein to mean that the organic wastes or sludges are released or removed from the source, collection agent or disposal unit to the individual, company, independent contractor or combination thereof who will be processing the organic wastes or sludges. The organic wastes or sludges may also be provided by another treatment facility or pre-treatment facility where the wastes or sludges have been already solidified or conditioned, but that need additional processing. Once the organic wastes or sludges are provided to the entity who will undertake the process contemplated herein, it can be further provided to the heated air system by at least one front end loader, tractor (with bucket and forks), auger, conveyor belt, storage box, storage unit or combination thereof.

Once the organic wastes or sludges are provided, a heated air system is provided that will work to a) efficiently convert organic wastes and sludges into soil mediums or alternative fuel mediums; b) ensure that the soil mediums and alternative fuel mediums are non-odoriferous, non-pathogenic and/or virus-free; c) mass reduce large quantities of organic sludges and wastes; d) mass reduce organic wastes and sludges by a 5 to 1 ratio; e) produce soil mediums or alternative fuel mediums that are or approach Class A or “exceptional quality” rating making them safe to recycle and/or f) convert both solids and liquids to soil mediums or alternative fuel mediums, where the treated solids can be safely recycled to agriculture markets and liquids can be recycled as wash-down water.

It should be understood that a contemplated heated air system is not an incineration device or process. The organic wastes or sludges that are provided will not be incinerated during the heated air part of the process. A contemplated heated air system comprises a heated air dryer, such as the ITS Cyclonic Air Rotary Dryer. Hot air is pumped or forced into the dryer after ambient air is heated to a specific temperature by a burner or other heating device. Contemplated heated air systems are also electronically or digitally operated in order to ensure quality control. In addition to the heated air dryer, it is contemplated that the heated air system comprises a mixer for conditioning or blending the organic wastes or sludges. Contemplated heated air systems, as described herein, are approved processes to reduce pathogens (PFRP), as listed in Chapter 10 of the U.S. EPA Prepared Guidance: “Environmental Regulations and Technology” under 40 CFR, Part 503.

An exhaust system is also provided during contemplated processes, wherein the exhaust system is coupled to the heated air system. The exhaust system is designed to remove and/or exhaust any dust particles or undesirable gases from the process of converting organic wastes or sludges to soil medium or alternative fuel medium. Contemplated exhaust systems may comprise a dust collector, carbon bed filters, low current plasma systems, wet scrubber systems, exhaust fans and combinations thereof. Components of the exhaust system may be connected to one another and to the heated air system by any suitable connection apparatus, including metal pipes, conduits, PVC, plastic or composite pipes or a combination thereof. A closed loop system may also be created in order to recycle air or heat produced by the use of the heated air system. The goal in removing dust particles and/or undesirable gases is to break each component down to the point where they can safely be disposed of or released back into the atmosphere—such as by converting carbon monoxide (CO) to carbon dioxide (CO₂). If any particles or undesirable gases that are collected cannot be further broken down in order to make them environmentally acceptable, they should at least be able to be put into solution or properly stored, such that they can be disposed of in a manner that complies with all current Environmental Protection Agency regulations.

The at least one collection of organic wastes or sludges are introduced into the heated air system by methods and apparatus previously described. In one contemplated embodiment, the at least one collection of organic wastes or sludges are introduced into a cement, fertilizer or feed rotary batch mixer operated either horizontally or vertically. The batches may range from about one to about twelve tons or cubic yards in volume of organic wastes or sludges. Organic wastes that have been belt pressed or dewatered may be introduced into the heated air system by any suitable mechanical apparatus, such as those previously described herein. Organic sludges or slurries may be introduced into the heated air system by a pump and conduit.

Once the at least one collection of organic wastes or sludges are introduced into the heated air system, the heated air system is operated in order to convert the at least one collection of organic wastes or sludges to a soil medium or alternative fuel medium. At least part of the heated air system, such as a rotary drum, is rotated while super-heated air is pumped into the heated air system and makes contact with the tumbling waste and/or sludge mass within the drum. The super-heated ambient air is produced by a burner fired from natural gas, diesel, propane or thorough gasification of various products, and is transferred by blower or fan through a duct system into the mixer/rotary drum for a desired period of time. At the same time, air, which includes any dust particles or undesirable gases, is exhausted from the heated air system to the exhaust system by using a blower or fan system, which draws the emissions through a cyclone dust collector and an air scrubber system.

The dried, neutral odor solids—which comprise soil medium and/or alternative fuel medium—are discharged via an auger or closed conveyer system. Because the solids have absorbed heat to temperatures exceeding 176° F., they are now disinfected and meet EPA Class A or Exceptional Quality beneficial reuse parameters, as listed under 40 CFR, Part 503 Regulations.

Agents that enhance texture, appearance, increased nutrient value, deodorization or a combination thereof may also be added to the processes described and contemplated herein, if necessary. At least part or all of the agents added may be commingled before or after the drying process is conducted.

Contemplated end product user groups are the following industries:
AGRICULTURE: organic farming of vegetables, crops and fruit trees has increased by 20% each of the last 5 years.
HORTICULTURE: nurseries, freeway landscaping, golf courses, landscaping and—the public sector.
SILVICULTURE & LAND RECLAMATION: forest, Christmas trees, landfill cover and road shoulders.
OTHER MARKETS: airports, parks, cemeteries, lawns, gardens, military installations.
ORGANIC CATTLE FEED: the use of organic cattle feed is growing by 10% or more each year.
   The processes described herein a) efficiently convert organic wastes and sludges into soil mediums or alternative fuel mediums; b) ensure that the soil mediums and alternative fuel mediums are non-odoriferous, non-pathogenic and/or virus-free; c) mass reduce large quantities of organic sludges and wastes; d) mass reduce organic wastes and sludges by a 5 to 1 ratio; e) produce soil mediums or alternative fuel mediums that are or approach Class A or “exceptional quality” rating making them safe to recycle and/or f) convert both solids and liquids to soil mediums or alternative fuel mediums, where the treated solids can be safely recycled to agriculture markets and liquids can be recycled as wash-down water. In addition, the processes described herein are individually in a category of EPA approved technologies, but are being utilized herein in a novel fashion. The processes and equipment described herein are designed to be portable, since it would be ideal to be able to move equipment around to deal with the needs of specific areas. The processes described herein render regulatory compliance to generators, and has the capability of reducing pollution on a global scale. The end product of soil mediums and alternative fuel mediums feature significant recycle values on a renewable basis.

### EXAMPLE

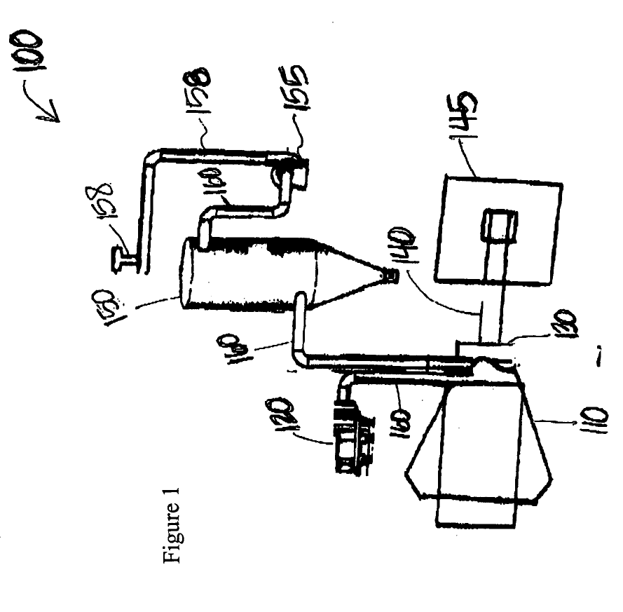

FIG. 1 shows a contemplated arrangement for processing organic wastes and sludges (100) according to the subject matter herein, comprising a mixer (110) coupled to a burner (120), a product outlet (130), a food intake (140) and a dust collector (150) by a plurality of conduits or pipes (160). The food intake (140) is coupled to a hopper (145), and the dust collector (150) is coupled to an exhaust fan (155) and exhaust conduits or pipes (158).

Contemplated arrangements such as the one shown in FIG. 1 addresses the needs of municipalities, animal and poultry as well as industrial waste generators. The system mass reduces the waste, disinfects it of bacteria, viruses and foul odor while making the end product safe and recyclable as a soil medium.

1. A process of producing soil mediums or alternative fuel mediums from organic wastes or sludges, comprising:
providing at least one collection of organic wastes or sludges;
providing a heated air system;
providing an exhaust system coupled to the heated air system;
introducing the at least one collection of organic wastes or sludges to the heated air system;
operating the heated air system in order to convert the at least one collection of organic wastes or sludges to a soil medium or alternative fuel medium; and
exhausting any dust particles or undesirable gases by utilizing the exhaust system.

2. The process of claim 1, wherein the at least one collection of organic wastes or sludges originates from a municipality, an animal or poultry facility, a paper mill or a combination thereof.

3. The process of claim 2, wherein the at least one collection of organic wastes or sludges comprises at least one liquid, at least one slurry, at least one solid or a combination thereof.

4. The process of claim 3, wherein the at least one collection of organic wastes or sludges comprises at least one liquid.

5. The process of claim 3, wherein the at least one collection of organic wastes or sludges comprises at least one solid.

6. The process of claim 1, wherein the heated air system comprises at least one rotary drum.

7. The process of claim 1, wherein the heated air system heats air to at least about 150° F.

8. The process of claim 7, wherein the heated air system heats air to at least about 170° F.

9. The process of claim 8, wherein the heated air system heats air to at least about 175° F.

10. The process of claim 1, wherein the exhaust system comprises at least one dust collector.

11. The process of claim 1, wherein the exhaust system comprises at least one wet scrubber, at least one plasma system, at least one carbon bed or a combination thereof.

12. The process of claim 11, wherein the exhaust system comprises at least one wet scrubber.

13. The process of claim 1, further comprising collecting a plurality of dust particles, at least one undesirable gas or a combination thereof from the exhaust system.

14. The process of claim 1, wherein exhausting comprises removing a plurality of dust particles, at least one undesirable gas or a combination thereof from the heated air system.

15. The process of one of claims 13 or 14, further comprising disposing of the plurality of dust particles, the at least one undesirable gas or the combination thereof inn accordance with EPA Regulations.

16. The process of claim 1, wherein the exhaust system comprises at least one blower, fan or combination thereof.

17. A soil medium produced by the method of claim 1.

18. An alternative fuel medium produced by the method of claim 1.
